(19) United States
(12) Patent Application Publication
(10) Pub. No.: US 2005/0010903 A1
(43) Pub. Date: Jan. 13, 2005

(54) Method for creating a data processing program

(75) Inventor: Joachim Morgenstern, Jockgrim (DE)

Correspondence Address: SUGHRUE MION, PLLC, 2100 PENNSYLVANIA AVENUE, N.W., SUITE 800, WASHINGTON, DC, 20037, US

(73) Assignee: SIEMENS AKTIENGESELLSCHAFT

(21) Appl. No.: 10/826,256

(22) Filed: Apr. 19, 2004

Related U.S. Application Data
(63) Continuation of application No. PCT/DE02/03944, filed on Oct. 18, 2002.

(30) Foreign Application Priority Data
Oct. 19, 2001 (DE) 10151750.5

(51) Int. Cl. G06F 9/44

(52) U.S. Cl. 717/120; 717/162

(57) ABSTRACT

A method for creating a data process program, in which a number of modules (2), which are stored in a memory unit (8), are selected and interlinked in accordance with a required task. Thereby, a particularly high degree of flexibility is achieved, while allowing a retroactive modification or adaptation of the data processing program in a relatively simple manner. To link the modules, an identifier is assigned to each selected module (2) by means of a central, predefined allocation table (10), wherein the identifier determines the next module (2) that is to be called after the execution of the current module (2).

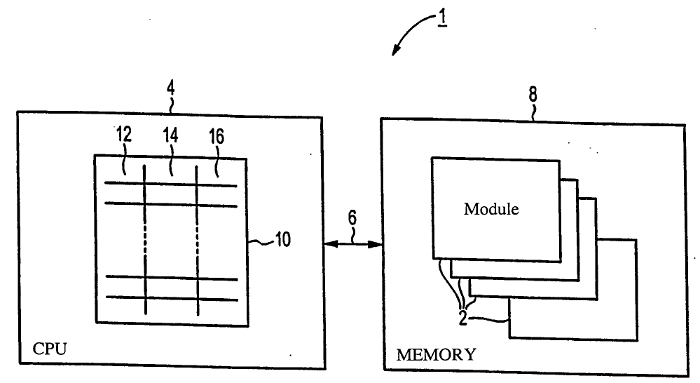

This is a Continuation of International Application PCT/DE02/03944, with an international filing date of Oct. 18, 2002, which was published under PCT Article 21(2) in German, and the disclosure of which is incorporated into this application by reference.

### FIELD OF AND BACKGROUND OF THE INVENTION

The invention relates to a method for creating a data processing program, in which a number of modules stored in a memory unit are selected and interlinked, as required by a specific task.

In automation processes, data processing systems are used to various degrees in diverse applications. These automation processes are employed in comparatively large, complex systems in the industrial field. Alternatively, these automation processes are employed in decentralized, relatively small components in mobile applications or in consumer products. For its proper operation, a data processing system typically has a data processing program. Through the appropriate processing of data, the data processing program enables a function-oriented mode of operation of the respective system or component.

Typically, in creating data processing programs, which control, for example, individual processes in an automation system, or which, in the manner of input/output modules, enable the operator to communicate with the system, a suitably selected sequence of instructions is generated or defined. When the data processing program is executed, the system goes through the instructions in sequence, such that the individual instruction steps are executed in the predefined sequence. However, this approach of creating a data processing program can lead to relatively complex structures, which makes it more difficult to subsequently revise or modify the respective data processing program.

For these reasons, among others, task-specific, prefabricated components or modules are increasingly used to create data processing programs. These modules are typically stored and kept available in a memory unit to create the actual program. If needed, these modules are then suitably selected and interlinked to create the actual data processing program. Each of the modules can be designed to provide suitable intermediate results, such as, e.g., the output of text elements or the execution of specific logic operations.

Therein, a sequence of appropriately selected processing steps is pre-defined as a main program. With each processing step, a module that is suitable to execute the respectively required functions is called as a subroutine. However, even these methods for creating a data processing program have the drawback that, especially in relatively complex structures, any subsequent change or reprogramming can be very time-consuming.

### OBJECTS OF THE INVENTION

It is one object of the invention to provide a method for creating a data processing program, in which a number of modules that are stored in a memory unit are selected in accordance with a required task and interlinked. It is an associated object to ensure high flexibility, and make it comparatively easy to subsequently change or adapt the data processing program.

### SUMMARY OF THE INVENTION

This and other objects are achieved by a method for creating a data processing program, in which modules are stored in a memory unit. In accordance with a specific task, certain ones of the modules are then selected and interlinked. Therein, a respective identifier is assigned to each of the selected modules via a centrally predefined allocation table. The respective identifier specifies a subsequent module that is to be called after a previous module is executed.

It is an underlying idea of the invention that, in the conventional methods for creating data processing programs, the sequence of instructions—which is typically predefined at the time of creating the data processing program and which must subsequently be strictly adhered to—significantly contributes to the complexity of the data processing programs and, thus, to the resulting lack of flexibility in making subsequent changes thereto. To facilitate the subsequent modifiability of the data processing program, the definition of the instruction sequence that must be adhered to when the program is executed should therefore be postponed to a particularly late point in the creation of the data processing program.

In creating the data processing program, this can be achieved by using selectable modules in that each selected module is merely assigned a piece of information or an identifier that specifies the subsequent module that is to be called after the respective module has been run. A later program modification is then readily possible by adapting the identifier, which is stored in the allocation module, for the module whose linkage is to be changed. The sequential structure of the data processing program, which limits the flexibility in a subsequent change, is created only in a comparatively late process step, i.e., when the data processing program is finally compiled or generated based on the separately defined linkage of the selected modules.

The method according to the invention is particularly suitable for creating a data processing program that is a module adapted to create a dialog between the user and the data processing system. For this purpose, the created data processing program is advantageously an input/output module or a module for man-machine communication. In particular, the modules to be interlinked, which are stored in the memory unit, are dialog components, e.g., selection modules, multiple selection modules or input modules; text modules, e.g., short text units, entire documents or parts thereof; and/or action components, e.g., instructions to start other programs.

The method is particularly suitable for creating user-tailored, specifically adapted dialogs based on a very large number of possible information sources or text modules. To document extensive know-how, a specific query and presentation of individual information components, which is adapted to a predefinable question, is particularly important. In this case, all of the available information can be stored in the memory unit as a large number of individual text modules or documents. A dialog that is adapted to a predefinable question, via which the most relevant pieces of information can be selected from the large amount of information, can advantageously be created in the allocation module by specifying suitable links between individual text modules. The text modules can also be supplemented by teaching programs. The specific management or structuring of the dialog or the dialog module to be created merely requires assigning an identifier that is adapted to the selected text modules, such that the total information or the information modules per se, which are stored in the memory unit, can be kept unchanged.

So as to reliably create a suitable data processing program even for relatively complex tasks, an advantageous embodiment of the invention employs an allocation table. For each module to be used, this allocation table stores not only the identifier that specifies the subsequent module to be called, but also a number of parameter characteristics, by means of which the parameters to be transferred to the subsequent module are identified and which are required to reliably call that module. This ensures that, when a subsequent module is called, any characteristics that may have to be transferred as the input values of that module are properly taken into account, if necessary. This reliably prevents accidentally omitting the necessary transfer of parameters for user-tailored initiation of the subsequent module's functions.

Particular advantages of the invention are that, by linking the suitably selected modules by means of an allocation module or an allocation table, the creation of a sequence of instructions is postponed to a relatively late process stage, i.e., to the actual compiling or generating of an independently executable program module. However, before the program module is generated, no boundary conditions have to be met as a result of the definition of the sequence. Accordingly, it is relatively simple to change linkages by changing the respective identifier for each subsequent module. Thus, in particular when dialog programs are to be created, which require a structured and precise presentation of information segments that are suitably selected from a plurality of information sources, a specifically adapted dialog sequence is achieved by means of respective linkages via the allocation table.

Especially when individual text modules are interlinked, it is not necessary to adhere to a sequence in advance. Instead, this sequence is generated only when the cross-references that are specific to the text module are processed one after the other. The program can be subsequently changed by modifying the linkage via the allocation module or the allocation table, without requiring any further modifications. As a result, a fundamental change in the dialog sequence is relatively easily achieved, while the same kind of text modules are retained.

Furthermore, through the links or cross-references that are stored in the allocation module or the allocation table, it is possible to use existing additional information to further interlink individual modules on the output side, especially in an application for creating a user-tailored dialog system. This makes it possible to take adequate account of a potential result at the time when the linkages of the text modules are created, such that the dialog to be generated is particularly well structured. As a result, experiences or additional knowledge can be taken into account in the allocation table, which is provided as a kind of structured list, in view of a possible further course of the respective dialog with respect to the available information.

### BRIEF DESCRIPTION OF THE DRAWINGS

An exemplary embodiment of the invention will now be described with reference to the drawing. The drawing schematically shows an exemplary system for creating a data processing program.

### DETAILED DESCRIPTION OF THE PREFERRED EMBODIMENTS

The system 1 is configured for creating data processing programs with comparatively high flexibility, such that even a subsequent change or adaptation of the respective data processing program is possible with little effort. In particular, the system 1 is configured to generate a dialog module or input/output module that enables man-machine communication in a particularly advantageous and precise manner.

The system 1 is configured to create data processing programs using prefabricated, task-specific components or modules 2. Therein, the system 1 has a central computing unit 4 to run the actual processes involved in creating the data processing programs. As indicated by the double arrow 6, the computing unit 4 communicates with a memory unit 8 in which the modules 2 are stored.

To create a data processing program, the computing unit 4 accesses, as needed, the modules 2 stored in the memory unit 8 and selects suitable modules 2, as required by a specific task and depending on the functions to be performed by the data processing program that is being created. Subsequently, the modules 2 are suitably interlinked, such that, in the form of a compilation and based on the modules 2 that are selected in accordance with the specific task, an independently executable data processing program is generated in the computer unit 4.

To ensure particularly high flexibility, in particular with respect to any subsequent changes to the thus created data processing program, the system 1 is configured in such a way that the definition of a sequential flow of program steps is postponed to a comparatively late process step in the generation of the data processing program. In particular, initially, the task-specific selection and linkage of the modules 2 is independent of the sequence of the program steps, which must ultimately be adhered to. Therein, the modules 2 are selected and interlinked via an allocation table 10, which is configured as a structured list and which is stored in the computing unit 4.

In a first column 12, the allocation table 10 contains, in a matrix-type organization of information, a list of the modules 2 that are to be activated for the respective data processing program. Therein, each of the modules 2 to be activated is stored with a module-specific identifier. The allocation table 10 further contains another column 14 that specifies, for each module 2 listed in the column 12, the module 2 that must be called next, after the respective, previous module 2 has been run during the execution of the data processing program. The allocation table 10 further contains a third column 16, which stores, for each module 2, a number of parameter characteristics that must be transferred to the next module 2 to be called as input quantities for that module 2.

When the data processing program is created, each of the selected modules 2 is initially assigned an identifier, based on the allocation table 10. This identifier specifies the module 2 to be called next, after the respective, previous module 2 has been run. Furthermore, the parameter characteristics stored in the third column 16 are used to define the input data that must be transferred to the next module 2 to be called.

By employing the allocation table 10, a sequential listing of the modules 2 to be used is initially not required. Rather, the modules 2 to be used can be listed in any sequence in the allocation table 10, without thereby affecting the actual creation of the data processing program. This makes it possible to achieve a comparatively high flexibility in creating the data processing program through a suitable linking of the modules 2. In particular, this simplifies any subsequent editing or modifying of the data processing program. Therein, a fundamental, structural change in the data processing program is already achieved by a respective modification of an assignment within the allocation table 10. The sequence of the consecutive instruction sets that is actually to be taken into account is defined merely by individual assignments, in which each module 2 in the allocation table 10 is assigned to the module 2 that is subsequently to be called. Globally, i.e., with respect to the entire data processing program to be created, the sequence of the individual instructions is necessary only at a comparatively late stage, i.e., at the time when the executable program is generated.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

1. A method for creating a data processing program, comprising:
storing a plurality of modules in a memory unit; and
selecting and interlinking a subset of the plurality of modules, as required by a specific task;
wherein, for interlinking the selected modules, a respective identifier is assigned to each of the selected modules via a centrally predefined allocation table; and wherein the respective identifier specifies a subsequent one of the modules that is to be called after a respective, one of the modules that is assigned to the respective identifier is executed.

2. The method as claimed in claim 1, wherein the data processing program comprises at least one of an input/output module and a module for man-machine communication.

3. The method as claimed in claim 1, wherein the allocation table comprises a plurality of parameter characteristics by which parameters are identified that are transferred to the subsequent one of the modules for calling the subsequent one of the modules.

4. A method for creating a data processing program, comprising:
selecting a plurality of modules stored in a memory unit in accordance with a specific task; and
interlinking the plurality of modules, including assigning each of the selected modules a respective identifier via a centrally predefined allocation table,
wherein a given one of the respective identifiers specifies a module called subsequent to the respective module to which the given identifier is assigned.
